(19) United States
(12) Patent Application Publication
(10) Pub. No.: US 2018/0111806 A1
(43) Pub. Date: Apr. 26, 2018

(54) DUAL CAPACITY WINCH USING TWO MOTORS AND A SINGLE GEARBOX AND DRUM

(71) Applicant: INGERSOLL-RAND COMPANY, DAVIDSON, NC (US)

(72) Inventor: Stephen David Louis Snider, Kent, WA (US)

(21) Appl. No.: 15/333,002

(22) Filed: Oct. 24, 2016

(51) Int. Cl. B66D 1/22; B66D 1/08

(52) U.S. Cl. CPC B66D 1/225; B66D 2700/0133; B66D 1/08

(57) ABSTRACT

The winch includes a gear assembly having a first stage and a last stage. A first input is coupled to the first stage and a second input is coupled to the last stage. In a first operative condition, the first input drives a sun gear of the first stage while a planetary carrier of the last stage is fixed so that the sun gear of the first stage drives the gear assembly to output motion through a ring gear. In a second operative condition, the second input drives the planetary carrier of the last stage while the sun gear of the first stage is fixed so that the planetary carrier of the last stage drives the gear assembly to output motion through the ring gear. The first condition provides a first output torque and the second condition provides a second output torque less than the first output torque.

### CROSS-REFERENCE TO RELATED APPLICATION(S)

This application is filed concurrently on Oct. 24, 2016 with U.S. patent application Ser. No. ______ to Stephen Snider, entitled “MECHANISM TO SELECTIVELY FIX OR FREE PLANETARY CARRIER OF EPICYCLIC GEARBOX,” the disclosure of which is hereby incorporated entirely herein by reference.

### BACKGROUND

### Technical Field

The present disclosure relates to a machine or apparatus for hauling or lifting, and in particular to a winch.

### State of the Art

A winch is a machine with one or more drums on which to coil a rope, cable, or chain for hauling or hoisting. The winch may be used to haul in (spool) or pay out (unspool) the cable, depending on the mode of operation. For example, as the cable is hauled in or paid out, the object attached to the cable may be lifted or lowered, retracted or extended, etc. Likewise, the cable may be made taught or let loose, depending on the direction of rotation of the winch, or in particular the drum of the winch.

However, any one winch may be designed with a particular purpose to lift or haul an item or object having a certain weight, or range of weight. Such a winch may thus have limited applicability in an operation where there is a need to lift or haul items or objects of different weights or at different speeds.

Accordingly, there is a need for a winch that provides a means by which the winch may have multiple weight bearing and/or speed capabilities.

### SUMMARY

The present disclosure relates to a machine or apparatus for hauling or lifting, and in particular to a winch.

An aspect of the present disclosure includes a winch comprising: a gear assembly having a first stage and a last stage; a first input coupled to the first stage; a second input coupled to the last stage; wherein in a first condition the first input drives a sun gear of the first stage and a planetary carrier of the last stage is fixed, the sun gear of the first stage driving the gear assembly to output motion through a ring gear, and wherein under a second condition the second input drives the planetary carrier of the last stage and the sun gear of the first stage is fixed, the planetary carrier of the last stage driving the gear assembly to output motion through the ring gear.

Another aspect of the present disclosure includes wherein in the first condition the gear assembly provides a first output torque and in the second condition the gear assembly provides a second output torque less than the first output torque.

Another aspect of the present disclosure includes wherein the first and second conditions are asynchronous and wherein the ring gear is driven in a first direction in both the first and second conditions.

Another aspect of the present disclosure includes a winch comprising: a planetary gear assembly having a first stage and a last stage; a first input coupled to a sun gear of first stage; a second input coupled to a planetary carrier of the last stage; wherein each of the first input and second input is configured to transition between an operational state and a locked state; wherein under the condition the first input is in the operational state, the second input fixes the planetary carrier of the second stage and the first input drives the sun gear of the first stage to rotate a ring gear of the planetary gear assembly, and wherein under the condition the second input is in the operational state, the first input fixes the sun gear of the first stage and the second input drives the planetary carrier of the last stage to rotate the ring gear.

Another aspect of the present disclosure includes wherein the first and second inputs each have a forward and reverse state, wherein in the forward state the ring gear is driven in a first direction and in the reverse state the ring gear is driven in a second direction opposite the first direction.

Another aspect of the present disclosure includes a locking mechanism coupled to one of the first and second inputs, wherein the locking mechanism maintains the respective input in the locked state.

Another aspect of the present disclosure includes a winch comprising: a gear assembly having a first stage and a last stage; a first input coupled to the first stage; and a second input coupled to the last stage; wherein operation of the first input drives the gear assembly in a first direction at a first output torque, and wherein operation of the second input drives the gear assembly in the first direction at a second output torque less than the first output torque.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 is a schematic view of an embodiment of a winch in accordance with the present disclosure;

FIG. 2 is a flowchart of the control logic of an embodiment of a winch in accordance with the present disclosure; and

FIG. 3 is a hydraulic schematic of the control logic of an embodiment of a winch in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

The drawings depict illustrative embodiments of a hauling or lifting apparatus 10. These embodiments may each comprise various structural and functional components that complement one another to provide the unique functionality and performance of the apparatus 10, the particular structure and function of which will be described in greater detail herein. For example, the apparatus 10 may comprise a gear assembly 20, one or more inputs, one or more stopping devices, and a control 60, among other various components to be described herein.

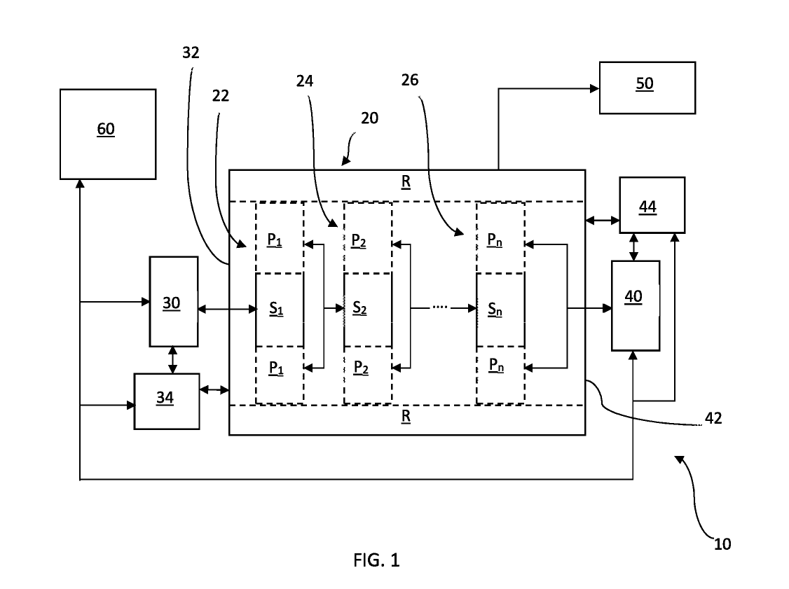

Referring to the drawings, FIG. 1 depicts an illustrative embodiment of hauling or lifting apparatus 10. The apparatus 10 may be, for example, a mechanical device configured to haul in (spool) or pay out (unspool), and, in particular, may be configured to haul in our pay out a cable, rope, cord, chain, line or other similar linear length of material wound about the device. Embodiments of the apparatus 10 may comprise the apparatus 10 being a winch-type apparatus. The present disclosure may refer to the apparatus 10 as a winch 10, or vice versa.

Embodiments of the winch 10 may comprise a gear assembly 20. The gear assembly 20 may comprise a first end 32 and a second end 42, wherein in some embodiments the first end 32 and the second end 42 may oppose one another, or at least be positioned and/or oriented opposite one another on the gear assembly 20. Embodiments of the winch 10 may comprise the gear assembly 20 being a planetary gear assembly, wherein the planetary gear assembly may have a single stage or multiple stages. For example, as depicted, the gear assembly 20 may have a first planetary gear assembly 22 as the first stage, a second planetary gear assembly 24 as the second stage, and so on and so forth until the gear assembly 20 may have a last planetary gear assembly 26 as the last stage. In other words, the gear assembly 20 may be configured with any number of planetary gear assemblies to achieve the desired gear reduction ration, direction of motion (rotation), torque control, and speed of rotation, among other desired characteristics. Embodiments of the winch 10 may comprise the first planetary gear assembly 22 being positioned closer to the first end 32 and the last planetary gear assembly 26 being positioned closer to the second end 42.

Embodiments of the apparatus 10 may comprise the gear assembly 20 having a single ring gear R for each of the planetary gear assemblies 22, 24, and 26. In other words, each of the planetary gear assemblies 22, 24, and 26 may have an individual sun gear and an individual set of planet gears coupled to a planet carrier, but have a common ring gear R. For example, the first planetary gear assembly 22 may comprise a sun gear S₁ and a set of planetary gears coupled to a planetary carrier P₁. The teeth of the sun gear S₁ and the teeth of the set of planetary gears coupled to the planetary carrier P₁ may be configured to engage one another, such that as force is applied to either of the sun gear S₁ or the planetary carrier P₁, the resulting force is translated to the other. Moreover, the teeth of the planetary gears coupled to the planetary carrier P₁ and the teeth of the ring gear R may be configured to engage one another, such that the planetary gears coupled to the planetary carrier P₁ may translate any resulting force through the planetary carrier P₁ to the ring gear R. Further in example, the second planetary gear assembly 24 may comprise a sun gear S₂ and a set of planetary gears coupled to a planetary carrier P₂. The teeth of the sun gear S₂ and the teeth of the set of planetary gears coupled to the planetary carrier P₂ may be configured to engage one another, such that as force is applied to either of the sun gear S₂ or the planetary carrier P₂, the resulting force is translated to the other. Moreover, the teeth of the planetary gears coupled to the planetary carrier P₂ and the teeth of the ring gear R may be configured to engage one another, such that the planetary gears coupled to the planetary carrier P₂ may translate any resulting force through the planetary carrier P₂ to the ring gear R. Further still, the last planetary gear assembly 22 may comprise a sun gear Sₙ and a set of planetary gears coupled to a planetary carrier Pₙ. The teeth of the sun gear Sₙ and the teeth of the set of planetary gears coupled to the planetary carrier Pₙ may be configured to engage one another, such that as force is applied to either of the sun gear Sₙ or the planetary carrier Pₙ, the resulting force is translated to the other. Moreover, the teeth of the planetary gears coupled to the planetary carrier Pₙ and the teeth of the ring gear R may be configured to engage one another, such that the planetary gears coupled to the planetary carrier Pₙ may translate any resulting force through the planetary carrier Pₙ to the ring gear R.

Embodiments of the winch 10 may comprise the planetary gear assemblies 22, 24, and 26 being coupled to one another to translate force between one another. For example, embodiments of the winch 10 may comprise the planetary carrier P₁ of the first planetary gear assembly 22 being coupled to the sun gear S₂ of the second planetary gear assembly 24, as depicted by arrows in FIG. 1, such that in this way force may be translated between the first and second planetary gear assemblies 22 and 24 of the gear assembly 20. Likewise, embodiments of the winch 10 may comprise the planetary carrier P₂ of the second planetary gear assembly 24 being coupled to the sun gear of the next planetary gear assembly in the series, which for purposes of this disclosure may be depicted as sun gear Sₙ of the last planetary gear assembly 26, as depicted by arrows in FIG. 1, such that in this way force may be translated between the second and next, or last, planetary gear assemblies 24 and 26 of the gear assembly 20.

Embodiments of the winch 10 may comprise a first input 30. The first input 30 may be any mechanical, electrical, pneumatic, hydraulic, or other powered device that can input force to the gear assembly 20. For example, the first input 30 may be a motor. The first input 30 may be configured to generate force to drive the operation of the gear assembly 20. Moreover, the first input 30 may be configured to operate in a bimodal state, wherein the first input 30 may operate in a both a first direction and a second direction, wherein the second direction may be opposite that of the first direction, such as a forward direction and a reverse direction. The first input 30 may have an output that may be coupled to the sun gear S₁ of the first gear assembly 22 on the first side 32 of the gear assembly 20, as depicted with arrows in FIG. 1, such that any force output generated by the first input 30 may be translated to the sun gear S₁ of the first gear assembly 22 to drive the operation of the gear assembly 20. The planetary gear assemblies 22, 24 and 26 are designed to provide the maximum torque multiplication when the first input 30 drives the gear assembly 20 by way of the first sun gear S₁.

Embodiments of the winch 10 may comprise a second input 40. The second input 40, similarly to the first input 30, may be any mechanical, electrical, pneumatic, hydraulic, or other powered device that can input force to the gear assembly 20. For example, the second input 40 may be a motor. The second input 40 may be configured to generate force to drive the operation of the gear assembly 20. Moreover, the second input 40 may be configured to operate in a bimodal state, wherein the second input 40 may operate in a both a first direction and a second direction, wherein the second direction may be opposite that of the first direction, such as a forward direction and a reverse direction. The second input 40 may have an output that may be coupled to the planetary carrier P₂ of the last gear assembly 26 on the second side 42 of the gear assembly 20, as depicted with arrows in FIG. 1, such that any force output generated by the second input 40 may be translated to the planetary carrier P₂ of the last gear assembly 26 to drive the operation of the gear assembly 20. The planetary gear assemblies 22, 24 and 26 are designed to provide, more or less, a one-to-one drive ratio when the second input 40 drives the gear assembly 20 by way of the last planetary carrier Pₙ.

Embodiments of the winch 10 may comprise a first stopping device 34 being configured in operative communication with the first input 30 and/or the first side 32 of the gear assembly 20. The first stopping device 34 may be a control locking mechanism, a mechanical locking mechanism, a physical brake mechanism, an electrical brake mechanism, or a combination of any of these, wherein the first stopping device 34 may be configured to restrict, stop, limit, halt, check, control, or otherwise prevent the operation of the first input 30 or at least the generated force of the first input 30 from driving the sun gear S₁ of the first planetary gear assembly 22. As such, the first stopping device 34 may be configured to assist the first input 30 transition between an operative state and a locked state. For example, the first stopping device 34 may be a physical brake that interacts with the first input 30 in such a way, such as by friction, to stop the force generated by the first input 30 from reaching the sun gear S₁ of the first planetary gear assembly 22. The first stopping device 34 may also be a control input that interacts with the first input 30 to instruct the first input 30 to shut down or otherwise suspend operation to thereby stop the force generated thereby. Alternatively, the first stopping device 34 may also be configured to restrict, stop, limit, halt, check, control, or otherwise prevent, through the control of the first input 30, the rotation of the sun gear S₁ of the first planetary gear assembly 22. In other words, by preventing the rotation or operation of the first input 30, the first stopping device 34 may likewise prevent rotation or operation of the sun gear S₁ to hold the sun gear S₁ in a fixed or locked state relative to the remaining stages of the gear assembly 20.

Embodiments of the winch 10 may further comprise the first stopping device 34 being configured to be coupled to the first side 32 of the gear assembly 20, and in particular to at least the sun gear S₁ of the first planetary gear assembly 22. In this way, the first stopping device 34 may interact with the sun gear S₁ of the first planetary gear assembly 22 to restrict, stop, limit, halt, check, control, or otherwise prevent the rotation of the sun gear S₁. In this way, the first stopping device 34 may hold the sun gear S₁ in a fixed or locked state relative to the remaining stages of the gear assembly 20. In alternative embodiments, the sun gear S₁ of the first planetary gear assembly 22 may be configured to engage the first stopping device 34, or components thereof, which may be configured on the winch upright, or some other fixed component of the winch 10, to thereby hold the sun gear S₁ in the fixed or locked state.

Embodiments of the winch 10 may comprise a second stopping device 44 being configured in operative communication with the second input 40 and/or the second side 42 of the gear assembly 20. The second stopping device 44 may be a control locking mechanism, a mechanical locking mechanism, a physical brake mechanism, an electrical brake mechanism, or a combination of any of these, wherein the second stopping device 44 may be configured to restrict, stop, limit, halt, check, control, or otherwise prevent the operation of the second input 40 or at least the generated force of the second input 40 from driving the planetary carrier Pₙ of the last planetary gear assembly 26. As such, the second stopping device 44 may be configured to assist the second input 40 transition between an operative state and a locked state. For example, the second stopping device 44 may be a physical brake that interacts with the second input 40 in such a way, such as by friction, to stop the force generated by the second input 40 from reaching the planetary carrier Pₙ of the last planetary gear assembly 26. The second stopping device 44 may also be a control input that interacts with the second input 40 to instruct the second input 40 to shut down or otherwise suspend operation to thereby stop the force generated thereby. Alternatively, the second stopping device 44 may also be configured to restrict, stop, limit, halt, check, control, or otherwise prevent, through the control of the second input 40, the rotation of the planetary carrier Pₙ of the last planetary gear assembly 26. In other words, by preventing the rotation or operation of the second input 40, the second stopping device 44 may likewise prevent rotation or operation of the planetary carrier Pₙ to hold the planetary carrier Pₙ in a fixed or locked state relative to the remaining stages of the gear assembly 20.

Embodiments of the winch 10 may further comprise the second stopping device 44 being configured to be coupled to the second side 42 of the gear assembly 20, and in particular to at least the planetary carrier Pₙ of the last planetary gear assembly 26. In this way, the second stopping device 44 may interact with the planetary carrier Pₙ of the last planetary gear assembly 26 to restrict, stop, limit, halt, check, control, or otherwise prevent the rotation of the planetary carrier Pₙ. In this way, the second stopping device 44 may hold the planetary carrier Pₙ in a fixed or locked state relative to the remaining stages of the gear assembly 20. In alternative embodiments, the planetary carrier Pₙ of the last planetary gear assembly 26 may be configured to engage the second stopping device 44, or components thereof, which may be configured on the winch upright, or some other fixed component of the winch 10, to thereby hold the planetary carrier Pₙ in the fixed or locked state.

Specific details related to embodiments of one or more component parts of the first or second stopping devices 34 and 44 may be found in Applicant's co-pending U.S. patent application Ser. No. ______ to Stephen Snider, entitled “MECHANISM TO SELECTIVELY FIX OR FREE PLANETARY CARRIER OF EPICYCLIC GEARBOX,” the disclosure of which is hereby incorporated entirely herein by reference. For example, the first and second stopping devices 34 and 44 may incorporate a mechanical locking mechanism that permits portions of the gear assembly 20, such as, for example, the sun gear S₁ or the planetary carrier Pₙ, to contact other fixed physical components of the winch 10, such as the winch upright, to transfer or absorb the force or torque acting on the gear assembly 20 or the winch 10, or both, to thereby prevent rotation of either the sun gear S₁ or the planetary carrier Pₙ, as the case may be.

Embodiments of the winch 10 may further comprise a drum 50. The drum 50 may be configured to respond to input from the ring gear R. Embodiments of the winch 10 may comprise the exterior of the ring gear R being configured as the drum 50, about which the cable, rope, cord, chain, line or other similar linear length of material may be wound. As such, input to the gear assembly 20 from either the first input 30 or the second input 40, but not both together as the operation of the first and second inputs 30 and 40 is asynchronous, may serve to drive the ring gear R as the output of the operation of the gear assembly 20 in response to the input, to be described in greater detail herein. Alternative embodiments of the winch 10 may comprise the rotation of the ring gear R indirectly driving the rotation of the drum 50 to thereby influence the operation and function of the material wound about the drum 50.

Embodiments of the winch 10 may further comprise a control 60. The control 60 may comprise a switch, such as a lever, to activate the operations of the winch 10 and transition the winch 10 between a utility mode, used for heavy lifting or hauling of heavy objects, and a light mode, used for light lifting or hauling loads lighter than that of the utility mode. For example, the control 60 may be placed in a first position to instruct the first input 30 to drive the gear assembly 20. The control 60, in the first position, may also instruct the second input 40 and/or the second stopping device 44 to restrict, stop, limit, halt, check, control, or otherwise prevent the planetary carrier Pₙ of the last planetary gear assembly 26 from rotating. In other words, with the control 60 in the first position, the control 60 not only instructs the first input 30 to drive the operation of the gear assembly 20 through the sun gear S₁, but also contemporaneously instructs the second input 40 and/or the second stopping device 44 to restrict, stop, limit, halt, check, control, or otherwise prevent the planetary carrier Pₙ of the last planetary gear assembly 26 from rotating. In this way, the second input 40 may not operate while the first input 30 is in operation, resulting in the planetary carrier Pₙ of the last planetary gear assembly 26 being fixed while the sun gear S₁ of the first planetary gear assembly 22 drives the gear assembly 20. Such a configuration permits the gear assembly 20, including its various planetary gear assemblies 22, 24, and/or 26, to provide a first output torque. For example, the first output torque may result from a gear reduction ratio in the neighborhood of about 64:1. With the control 60 in the first position, the winch 10 may operate to move, lift, or haul heavy items and objects of several thousand pounds. With the winch 10 in the first position, the first input 30 may also be configured to operate in either the first or second direction, thus allowing the first input 30 to drive the drum 50 in either forward or reverse directions (i.e., pull in or pay out directions).

Further in example, the control 60 may be placed in a second position to instruct the second input 40 to drive the gear assembly 20. The control 60, in the second position, may also instruct the first input 30 and/or the first stopping device 34 to restrict, stop, limit, halt, check, control, or otherwise prevent the sun gear S₁ of the first planetary gear assembly 22 from rotating. In other words, with the control 60 in the second position, the control 60 not only may instruct the second input 40 to drive the operation of the gear assembly 20 through the planetary carrier Pₙ, but may also contemporaneously instruct the first input 30 and/or the first stopping device 34 to restrict, stop, limit, halt, check, control, or otherwise prevent the sun gear S₁ of the first planetary gear assembly 22 from rotating. In this way, the first input 30 may not operate while the second input 40 is in operation, resulting in the sun gear S₁ of the first planetary gear assembly 22 being fixed while the planetary carrier Pₙ of the last planetary gear assembly 26 drives the gear assembly 20. Such a configuration permits the gear assembly 20, including its various planetary gear assemblies 22, 24, and/or 26, to provide a second output torque, the second output torque being less than the first output torque. For example, the second output torque may result from a gear reduction ratio in the neighborhood of about 1:1, so that the ratio between the first output torque and the second output torque may be greater than a factor of 10, and perhaps greater than a factor of 50, and in some embodiments greater than a factor of 100. With the control 60 in the second position the winch 10 may operate to move, lift, or haul light items and objects of several hundred pounds, such as personnel or other relatively light objects. With the winch 10 in the second position, the second input 40 may also be configured to operate in either the first or second direction, thus allowing the second input 40 to drive the drum 50 in either forward or reverse directions (i.e., pull in or pay out directions).

Embodiments of the winch 10 may comprise the control 60 being a manually operated control, a digital control, or a combination of both. As a manual control, the control 60 may be a switch, lever, push-button, or the like, to transition the winch 10 between the first and second operating positions Likewise, the first and second inputs 30 and 40, as well as the first and second stopping devices 34 and 44, may also be manually operated through the use of switches, levers, push-buttons, or the like. These manually operated controls may be powered controls, with the operation of these manually operated controls sending a signal to the various corresponding components of the winch 10 to operate according to the control that is activated. For example, a single push-button may operate to switch the winch 10 between the first and second modes of operation, and the corresponding operation of the first and second inputs 30 and 40 and the first and second stopping devices 34 and 44, respectively. Similarly, the forward and reverse operation of the first and second inputs 30 and 40 may also operate by a push-button or the like.

The control 60 may therefore comprise a microprocessor that may provide the computational and logical control processing capabilities that empower the control 60 to govern the operational aspects of the first and second inputs 30 and 40 and the first and second stopping devices 34 and 44, respectively. Embodiments of the winch 10 may comprise the control 60 having memory for storage capabilities, such as one or more hard drives, solid state drives, and/or RAM or the like. The control 60 may thereby be configured to store therein a software program containing an algorithm that is accessible to and utilized by the microprocessor of the control 60. The algorithm may be a winch control algorithm, capable of directing the described operations of the winch 10 disclosed herein.

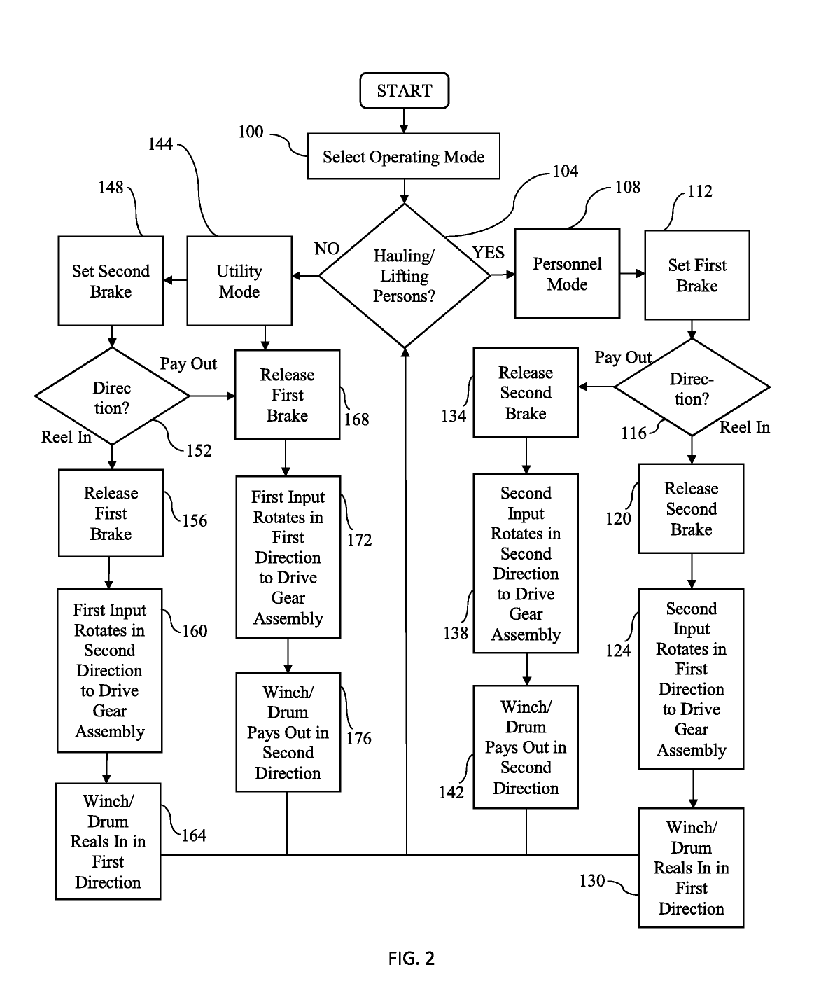

With reference now to additional figures, FIG. 2 depicts a flow chart illustrating operations of the winch 10 according to embodiments. In step 100, a user may begin to consider the circumstances under which the winch 10 will be used to thereby select the type of operation to be performed using the winch 10. Part of the decision may be, in step 104, to determine whether or not the winch 10 will be utilized to move or otherwise convey a lighter load? If a lighter load is to be conveyed by the winch 10, then the winch 10 may be placed in light mode, in step 108. As such, the first stopping device 34, or first brake, may be set in step 112 to fix one or both of the first input 30 and the sun gear S₁ of the first planetary gear set 22. Thereafter, the user may determine in step 116 whether or not the winch 10 is to pay out or reel in. To allow the drum 50 to reel in during the light mode, the second stopping device 44, or the second brake, may release in step 120 to permit the second input 40 to provide driving force to the drum 50 through the gear assembly 20. The second input 40 may rotate in a first direction to impart rotational motion to the drum 50 in step 124 through the gear assembly 20, as described herein. With the second input 40 rotating in the first direction, the resulting rotation of the drum 50 in step 130 may likewise be in the first direction, such that the rotation of the second input 40 and the rotation of the drum 50 are in the same direction. On the other hand, to allow the drum 50 to pay out during the light mode, the second stopping device 44, or the second brake, may release in step 134 to permit the second input 40 to provide driving force to the drum 50 through the gear assembly 20. The second input 40 may rotate in a second direction to impart rotational motion to the drum 50 in step 138 through the gear assembly 20, as described herein. With the second input 40 rotating in the second direction, the resulting rotation of the drum 50 in step 142 may likewise be in the second direction, such that the rotation of the second input 40 and the rotation of the drum 50 are in the same direction.

When the winch 10 is to operate in utility mode, such that the winch 10 may haul, lift, or convey heavy objects, items, or things, sometimes weighing several thousands of pounds, the user may place the winch 10 in utility mode, in step 144. As such, the second stopping device 44, or second brake, may be set in step 148 to fix in place, or otherwise hold fast, one or both of the second input 40 and the planetary carrier Pₙ of the last planetary gear set 26. In utility mode, the force required to fix the second input 40 and/or the planetary carrier Pₙ in place, requires the second stopping device 44, and thereby the planetary carrier Pₙ, to be able to hold a torque equal to or greater than the sum of the torque applied on the drum 50 (i.e., ring gear R) plus the first input 30. The amount of torque required to reel in or pay out items and objects weighing several thousand pounds is significant. Accordingly, the second stopping device 44 may incorporate a locking mechanism that is capable of sustaining these torque and force requirements, which is described in greater detail in Applicant's co-pending U.S. patent application Ser. No. _____ to Stephen Snider, entitled “MECHANISM TO SELECTIVELY FIX OR FREE PLANETARY CARRIER OF EPICYCLIC GEARBOX,” the disclosure of which is hereby incorporated entirely herein by reference. Once the second stopping device 44 is in place, the user may determine in step 152 whether or not the winch 10 is to pay out or reel in. To allow the drum 50 to reel in during the utility mode, the first stopping device 34, or the first brake, may release in step 156 to permit the first input 30 to provide driving force to the drum 50 through the gear assembly 20. The first input 30 may rotate in a second direction to impart rotational motion to the drum 50 in step 160 through the gear assembly 20, as described herein. With the first input 30 rotating in the second direction, the resulting rotation of the drum 50 in step 164 may be in the first direction, such that the rotation of the first input 30 and the rotation of the drum 50 are in opposite directions. On the other hand, to allow the drum 50 to pay out during the utility mode, the first stopping device 34, or the first brake, may release in step 168 to permit the first input 30 to provide driving force to the drum 50 through the gear assembly 20. The first input 30 may rotate in the first direction to impart rotational motion to the drum 50 in step 172 through the gear assembly 20, as described herein. With the first input 30 rotating in the first direction, the resulting rotation of the drum 50 in step 176 may be in the second direction, such that the rotation of the first input 30 and the drum 50 are in opposite directions.

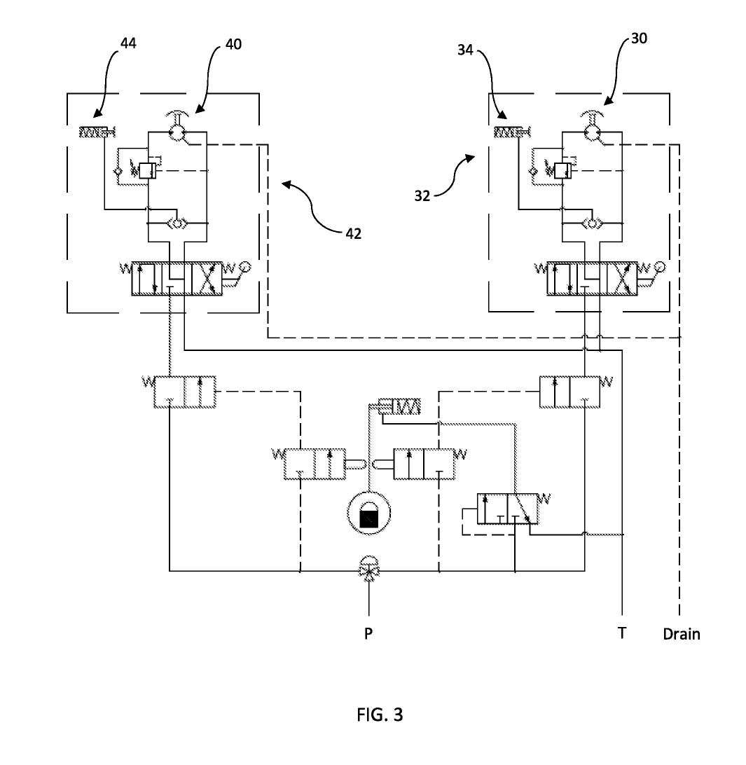

With reference now to FIG. 3, embodiments of the winch 10 may comprise the winch 10 operating through hydraulic power. For example, an illustrative embodiment of the hydraulic operation of the winch 10 is depicted. The first input 30 may be a hydraulic motor configured to operate in both a forward and backward rotation, or, in other words, a clockwise and counterclockwise rotation. The first stopping device 34 may be configured to operate in conjunction with the first input 30 to restrict or otherwise stop the first input 30 when needed, as described herein. The first stopping device 34 and the first input 30 may be configured on a first side 34 of the winch 10. Similarly, the second input 40 may be a hydraulic motor configured to operate in both a forward and backward rotation, or, in other words, a clockwise and counterclockwise rotation. The second stopping device 44 may be configured to operate in conjunction with the second input 40 to restrict or otherwise stop the second input 40 when needed, as described herein. The second stopping device 44 and the second input 40 may be configured on a second side 44 of the winch 10. Each of the first and second inputs 30 and 40 may be configured to impart force to the gear assembly 20 to drive the gear assembly 20 according to its intended purpose. However, as disclosed herein, operation of the first and second inputs is asynchronous, such that the first and second inputs 30 and 40 cannot impart force to the gear assembly 20 at the same time.

The dual nature of the winch 10 provides at least the advantage that users may utilize a single winch 10 that is able to handle utility loads of several thousand pounds, and with a turn of a switch, can also safely lift lighter loads having a limited load capacity of a few hundred pounds. The winch 10 therefore eliminates the need for two winches—a utility winch and a separate dedicated light-load winch. Indeed, the configuration of the winch 10, and in particular the difference between the gear reduction ratios, or the resulting torque output, between the utility mode and the light mode, as described herein, limits the reel in and pay out capacity of the winch 10 in the light mode to thereby ensure the safety of the items/objects/personnel on the end of the cable. Further still, the control 60 may also comprise an overload protection device (not depicted) that may sense characteristics of the load and restrict, slow, or halt operations of the winch 10 in light mode based on the sensed characteristics to protect the load being conveyed by the winch 10. For example, should the winch 10 begin pulling the light load at a rate faster than a safe rate, the control 60 may shut down operations of the winch 10 or otherwise slow or restrict operations to ensure safety.

The materials of construction of the winch 10 and its various component parts, may be formed of any of many different types of materials or combinations thereof that can readily be formed into shaped objects provided that the components selected are consistent with the intended operation of winches of the type disclosed herein. For example, and not limited thereto, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described winch 10 and its various component parts may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, 3-D printing, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

1. A winch comprising:
a gear assembly having a first stage and a last stage;
a first input coupled to the first stage;
a second input coupled to the last stage;
wherein in a first condition the first input drives a sun gear of the first stage while a planetary carrier of the last stage is fixed, the sun gear of the first stage driving the gear assembly to output motion through a ring gear, and
wherein in a second condition the second input drives the planetary carrier of the last stage while the sun gear of the first stage is fixed, the planetary carrier of the last stage driving the gear assembly to output motion through the ring gear.

2. The winch of claim 1, wherein the gear assembly is a multiple stage planetary gear assembly.

3. The winch of claim 1, wherein the first and second inputs are motors.

4. The winch of claim 1, wherein in the first condition the gear assembly provides a first output torque.

5. The winch of claim 4, wherein in the second condition the gear assembly provides a second output torque less than the first output torque.

6. The winch of claim 1, wherein the first and second conditions are asynchronous.

7. The winch of claim 1, wherein the ring gear is driven in a first direction in both the first and second conditions.

8. A winch comprising:
a planetary gear assembly having a first stage and a last stage;
a first input coupled to a sun gear of first stage;
a second input coupled to a planetary carrier of the last stage;
wherein each of the first input and second input is configured to transition between an operational state and a locked state;
wherein under the condition the first input is in the operational state, the second input fixes the planetary carrier of the second stage and the first input drives the sun gear of the first stage to rotate a ring gear of the planetary gear assembly, and
wherein under the condition the second input is in the operational state, the first input fixes the sun gear of the first stage and the second input drives the planetary carrier of the last stage to rotate the ring gear.

9. The winch of claim 8, wherein the first and second inputs drive the ring gear to rotate in the same direction.

10. The winch of claim 9, wherein the ring gear drives a drum of the winch.

11. The winch of claim 8, wherein the first and second inputs each have a forward and reverse state, wherein in the forward state the ring gear is driven in a first direction and in the reverse state the ring gear is driven in a second direction opposite the first direction.

12. The winch of claim 8, further comprising a locking mechanism coupled to one of the first and second inputs, wherein the locking mechanism maintains the respective input in the locked state.

13. The winch of claim 8, wherein the relative operational states of the first and second inputs are asynchronous.

14. A winch comprising:
a gear assembly having a first stage and a last stage;
a first input coupled to the first stage; and
a second input coupled to the last stage;
wherein operation of the first input drives the gear assembly in a first direction at a first output torque, and
wherein operation of the second input drives the gear assembly in the first direction at a second output torque, the second output torque being less than the first output torque.

15. The winch of claim 14, wherein the gear assembly is an epicyclic gear assembly.

16. The winch of claim 14, wherein the first input is coupled to a sun gear of the first stage.

17. The winch of claim 14, wherein the second input is coupled to a planetary carrier of the last stage.

18. The winch of claim 14, wherein operation of the first input and the second input are asynchronous.

19. The winch of claim 14, wherein operation of the first input outputs motion to a ring gear through the gear assembly.

20. The winch of claim 14, wherein operation of the second input outputs motion to a ring gear through the gear assembly.
